(19) United States
(12) Patent Application Publication
(10) Pub. No.: US 2014/0190895 A1
(43) Pub. Date: Jul. 10, 2014

(54) CALCIUM SALFATE SCALE -INHIBITING COMPOSITIONS

(71) Applicants: KING FAHD UNIVERSITY OF PETROLEUM AND MINERAL, (US); KING ABDULAZIZ CITY FOR SCIENCE AND TECHNOLOGY, (US)

(72) Inventors: FAIZUR RAHMAN, DHAHRAN (SA); SHAIKH ASROF ALI, DHAHRAN (SA)

(73) Assignees: KING ABDULAZIZ CITY FOR SCIENCE AND TECHNOLOGY, RIYADH (SA); KING FAHD UNIVERSITY OF PETROLEUM AND MINERALS, DHAHRAN (SA)

(21) Appl. No.: 13/737,900

(22) Filed: Jan. 9, 2013

(51) Int. Cl. C02F 1/68; C08G 75/22

(52) U.S. Cl. CPC C02F 1/68; C08G 75/22
USPC 210/700; 525/536

(57) ABSTRACT

The calcium sulfate scale-inhibiting compositions are polyelectrolyte antiscalant compositions for the inhibition of calcium sulfate scale formation in desalination plant feed brine, such as that typically used with reverse osmosis desalination plants. In order to inhibit the formation of calcium sulfate scale, the polyelectrolyte antiscalant compositions are mixed at a concentration between approximately 1 ppm and approximately 50 ppm into the desalination plant feed brine. The polyelectrolyte antiscalant composition may be either poly[disodium 3-(diallylamino)propanephosphonate]-alt-(sulfur dioxide), poly[sodium 5-(diallylcarboxymethylammonio)pentanoate]-alt-(sulfur dioxide), or poly[sodium 5-(diallylcarboxymethylammonio)pentanoate].

### BACKGROUND OF THE INVENTION

1. Field of the Invention

The present invention relates to the inhibition of scale formation in desalination plant feed brine, and particularly to calcium sulfate scale-inhibiting compositions that provide polyelectrolyte antiscalant compositions for inhibiting calcium sulfate scales and a method of using the same.

2. Description of the Related Art

Due to the needs for potable water in the developing world, there has been great interest in the development of antiscalants for controlling scaling in various industrial water treatment systems, such as desalination plants, cooling towers, boilers, oil wells, etc. Precipitation and scale deposition is a particular problem in reverse osmosis (RO) desalination plants and other water treatment installations. In the RO process, the dissolved salts in the feed water are concentrated as a reject brine stream due to the high salt rejection properties of membranes. If supersaturation occurs in the reject brine, and their solubility limits are exceeded, precipitation or scaling will occur.

Conventional scale inhibitors are generally referred to as “threshold agents”. Although generally effective, such conventional threshold agents are typically formed from organophosphates, polyacrylic acid, polymaleic acid, and hydrolyzed water-soluble copolymers of maleic anhydride. Newer antiscalants include polycarboxylates, phosphonates, phosphates, sulfonates and polyamides, along with the use of polyaspartic acids and their mixtures with surfactants and emulsifiers for inhibiting or delaying precipitation of scale forming compounds in membrane processes. These materials, however, are hazardous to humans and are very damaging to the environment. It would be desirable to be able to inhibit scale formation in the production of potable drinking water without the risk of harmful contamination, either to humans or the environment.

Thus, calcium sulfate scale-inhibiting compositions solving the aforementioned problems are desired.

### SUMMARY OF THE INVENTION

The calcium sulfate scale-inhibiting compositions inhibit calcium sulfate scale formation in desalination plant feed brine, such as that typically used with reverse osmosis desalination plants. In order to inhibit the formation of calcium sulfate scales, the polyelectrolyte antiscalant compositions are mixed into the desalination plant feed brine at a concentration between about 1 ppm and about 50 ppm. The compositions are polyelectrolyte antiscalant compositions that may be either poly[disodium 3-(diallylamino)propanephosphonate]-alt-(sulfur dioxide), poly[sodium 5-(diallylcarboxymethylammonio)pentanoate]-alt-(sulfur dioxide), or poly[sodium 5-(diallylcarboxymethylammonio)pentanoate].

These and other features of the present invention will become readily apparent upon further review of the following specification and drawings.

### BRIEF DESCRIPTION OF THE DRAWINGS

FIG. 1 is a reaction sequence describing the synthesis of a first embodiment of a calcium sulfate scale-inhibiting composition according to the present invention.

FIG. 2 is a structural formula of a second embodiment of a calcium sulfate scale-inhibiting composition according to the present invention.

FIG. 3 is a structural formula of a third embodiment of a calcium sulfate scale-inhibiting composition according to the present invention.

FIG. 4 is a graph illustrating the precipitation of a supersaturated (3 CB) aqueous solution of calcium sulfate without additional additives.

FIG. 5 is a graph illustrating the conductivity of the supersaturated calcium sulfate solution of FIG. 4 following mixing with 10 ppm of the calcium sulfate scale-inhibiting composition of FIG. 1.

FIG. 6 is a graph illustrating the conductivity of the supersaturated calcium sulfate solution of FIG. 4 following mixing with 10 ppm of the calcium sulfate scale-inhibiting composition of FIG. 2.

FIG. 7 is a graph illustrating the conductivity of the supersaturated calcium sulfate solution of FIG. 4 following mixing with 10 ppm of the calcium sulfate scale-inhibiting composition of FIG. 3.

Similar reference characters denote corresponding features consistently throughout the attached drawings.

### DETAILED DESCRIPTION OF THE PREFERRED EMBODIMENTS

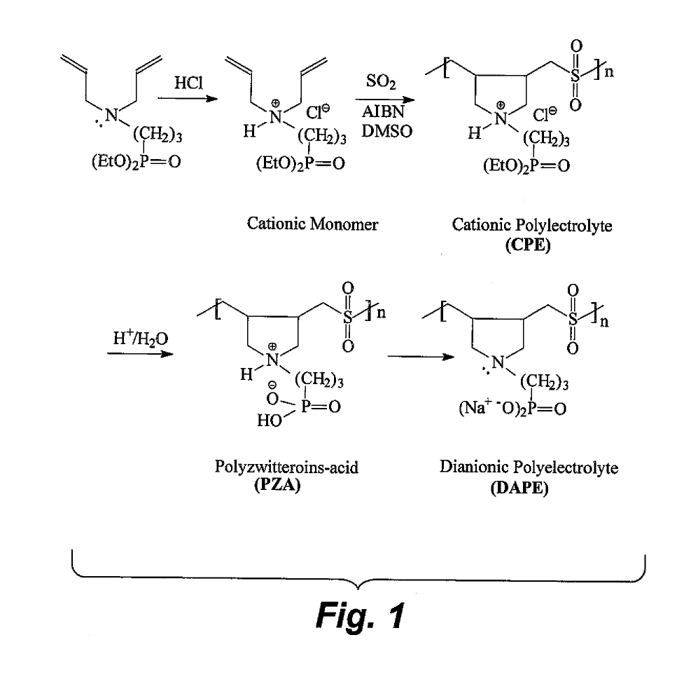

FIG. 1 illustrates a reaction scheme for the cyclopolymerization synthesis of the polyelectrolyte poly[disodium 3-(diallylamino)propanephosphonate]-alt-(sulfur dioxide), which, as will be described in detail below, is used as an antiscalant composition for inhibiting calcium sulfate scale formation in desalination plant feed brine, such as that typically used with reverse osmosis desalination plants. The monomer precursor N,N-diallyl-3-(diethylphosphonato)propylamine is first treated with anhydrous HCl to produce the cationic monomer N,N-diallyl-(diethylphosphonato)propylammonium chloride (experimentally, a 97% yield). The N,N-diallyl-(diethylphosphonato)propylammonium chloride then underwent cyclopolymerization with equimolar SO₂ in dimethyl sulfoxide (DMSO) at 0.26 g/mmol at a temperature of 60° C. for five hours. The resultant cationic polyelectrolyte (CPE) was poly[diallyl-3-(diethylphosphonato)propylammonium chloride]-alt-(sulfur dioxide), which was precipitated in acetone (producing an 83% yield). The CPE was characterized by elemental analysis, ¹H, ¹³C, and ³¹P NMR and IR spectroscopy. The intrinsic viscosity [η] of the CPE in 0.1 N NaCl at 30° C. was measured and found to be 0.432 dL/g.

Subsequently, 5.5 grams, or 14.6 mmol, of the CPE poly[diallyl-3-(diethylphosphonato)propylammonium chloride]-alt-(sulfur dioxide) was hydrolyzed in a solution of 6 M HCl at 90° C. for 48 hours. The homogeneous mixture was dialyzed against deionized water for 24 hours to produce the polyzwitterionic acid (PZA) poly[3-(diallylammonio)propanephosphonic acid]-alt-(sulfur dioxide) (at a 97% yield), which, upon treatment with two equivalents of NaOH (H₂O), was converted into the dianionic polyelectrolyte (DAPE) poly[disodium 3-(diallylamino)propanephosphonate]-alt-(sulfur dioxide)]. Both the PZA and the resultant DAPE were characterized by elemental analysis, ¹H, ¹³C, and ³¹P NMR and IR spectroscopy. It should be noted that the DAPE has only one phosphonate group, thus minimizing its relative weight % in the scale inhibitor composition.

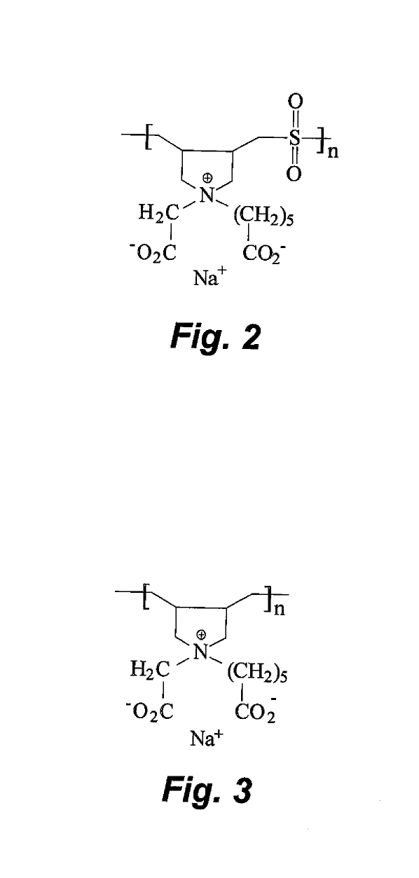

Experimentally, the poly[disodium 3-(diallylamino)propanephosphonate]-alt-(sulfur dioxide) was evaluated as a calcium sulfate scale inhibitor by addition to and mixing with the feed water of a brackish water reverse osmosis (RO) desalination plant, the polyelectrolyte being added in small quantities between 1 ppm and 50 ppm. Two alternative related substances were also evaluated in the same experiment: poly[sodium 5-(diallylcarboxymethylammonio)pentanoate]-alt-(sulfur dioxide) and poly[sodium 5-(diallylcarboxymethylammonio)pentanoate], the structures of which are shown in FIGS. 2 and 3, respectively. The latter two compositions were prepared by the known conventional technique of polymerization of functionalized diallyl quaternary salts. An example of such polymerization is described in M. M. Ali, H. P. Perzanowski, and S. A. Ali, “Polymerization of functionalized diallyl quaternary salt to poly(ampholyte-electrolyte)”, Polymer, 41, 5591-5600 (2000), which is hereby incorporated by reference in its entirety.

Table 1 below shows the composition of the brackish feed water and reject brine (corresponding to 70% recovery) used in the experimental evaluation.

TABLE 1
Analysis of feed water and reject brine in reverse osmosis plant

Brackish Water*

| Item | Feed (mg/l) | Reject Brine at 70% recovery (mg/l) |
|---|---|---|
| Cations | | |
| Al³⁺ | <1.0 | <1.0 |
| Ba²⁺ | <0.05 | 0.2 |
| Ca²⁺ | 281.2 | 866.3 |
| Cu²⁺ | <0.05 | 0.2 |
| Fe²⁺ | <0.1 | <0.1 |
| K⁺ | 32.0 | 88.9 |
| Mg²⁺ | 88.9 | 275.4 |
| Mn²⁺ | <0.05 | <0.05 |
| Na⁺ | 617.2 | 1,653 |
| P³⁺ | <0.1 | 0.88 |
| Sr²⁺ | 3.98 | 12.1 |
| Zn²⁺ | <0.05 | 0.07 |
| Anions | | |
| Br⁻ | 5.9 | 15.8 |
| Cl⁻ | 1,410 | 3,930 |
| F⁻ | <0.4 | <0.4 |
| HCO₃⁻ | 241 | 683 |
| NO₃⁻ | 7.7 | 19.1 |
| PO₄³⁻ | <0.6 | <0.6 |
| SO₄²⁻ | 611 | 2,100 |
| Others | | |
| SiO₂ | 29.8 | 81.4 |
| TDS | 3,329 | 9,730 |
| I (moles/l) | 0.06995 | 0.2087 |
| pH | 6.8 | 7.2 |

The three antiscalant compositions poly[disodium 3-(diallylamino)propanephosphonate]-alt-(sulfur dioxide), poly[sodium 5-(diallylcarboxymethylammonio)pentanoate]-alt-(sulfur dioxide), and poly[sodium 5-(diallylcarboxymethylammonio)pentanoate] were evaluated using synthetically prepared supersaturated 3 CB brine. The concentration measurement “CB” is defined such that a 1 CB concentration corresponds to a reject brine concentration at recovery ratio of 70%, as tabulated in Table 1 for brackish water. A CaCl₂ solution was prepared at six times the Ca²⁺ concentration in 1 CB solution (corresponding to 70% recovery in Table 1) and a Na₂SO₄ solution was prepared at six times the SO₄²⁻ ion concentration in 1 CB solution.

### Example 1

### Blank Control Solution

About 60 ml of the 6 CB calcium chloride solution was taken in a two-neck round bottom flask and antiscalant was added at a dose level of 10 ppm. The solution was heated to 50° C. by placing the round bottom flask on a heating mantle equipped with a magnetic stirrer. About 60 ml of 6 CB concentration sodium sulfate solution was prepared in a small glass bottle fitted with a Teflon cap, and heated to a temperature of 50° C. When both solutions reached 50° C., they were mixed together via stirring at 200 rpm. The concentration of the final solution after mixing was 3 CB (a mixture of about 2600 mg/l as Ca²⁺ and 6300 as SO₄²⁻).

Conductivity measurements were made at an interval of every 10 seconds to quantify the effectiveness of the antiscalants. A drop in conductivity indicates the precipitation of CaSO₄. Induction time was measured when precipitation started. The experiments were continued until equilibrium was reached. Visual inspection was carefully performed to see any turbidity arising from precipitation. The test conditions for evaluation of the three antiscalant additives are shown in Table 2 below.

TABLE 2
Additive test conditions

| Parameter | Condition |
|---|---|
| Temperature | 50° C. |
| Agitation | 200 rpm |
| Calcium Chloride | ~2600 mg/l as Ca²⁺ |
| Sodium Sulfate | ~6300 as SO₄²⁻ |

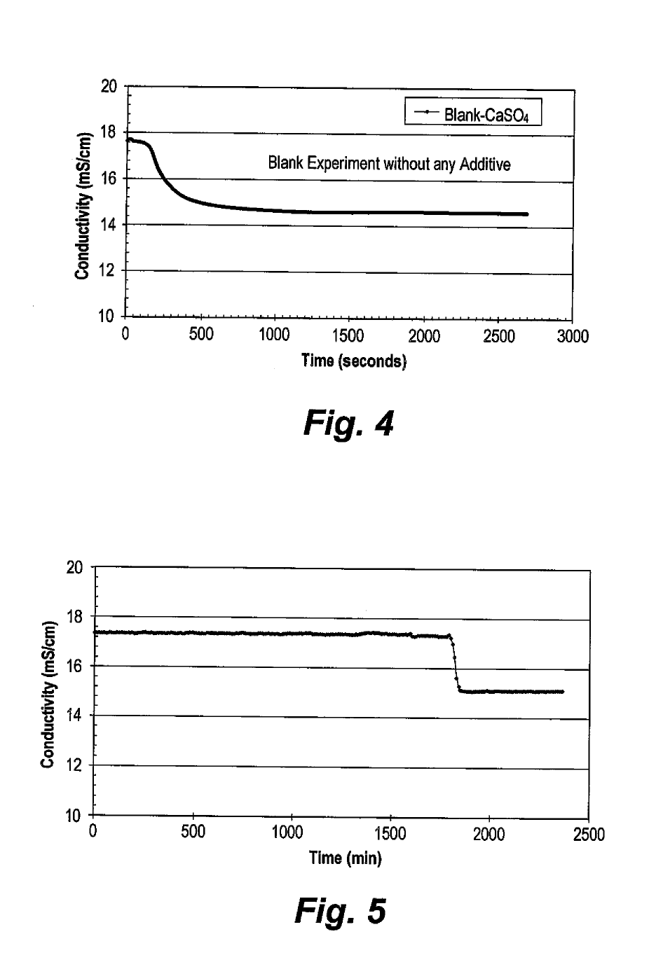

A blank, or control, experiment was first performed without any additive in the solutions. The results of this blank experiment serve as a basis to compare the performance of the present antiscalant additives. FIG. 4 shows the conductivity of the blank supersaturated solution (3 CB) of CaSO₄. The conductivity started at 17.44 mS/cm and dropped to 14.63 mS/cm at equilibrium.

### Example 2

### Poly[disodium 3-(diallylamino)propanephosphonate]-alt-(sulfur dioxide)

About 60 ml of the 6 CB calcium chloride solution was next taken in a two-neck round bottom flask and the antiscalant poly[disodium 3-(diallylamino)propanephosphonate]-alt-(sulfur dioxide), prepared as described above, was added at a dose level of 10 ppm. The solution was heated to 50° C. About 60 ml of 6 CB sodium sulfate solution was then prepared in a small glass bottle fitted with a Teflon cap and heated to 50° C. When both the solutions reached 50° C., they were mixed together via stirring at 200 rpm. The concentration of the final solution after mixing was 3 CB. Conductivity measurements were made at an interval of every 10 seconds to quantify the effectiveness of the antiscalant poly[disodium (diallylamino)propanephosphonate]-alt-(sulfur dioxide). A drop in conductivity indicates the precipitation of CaSO₄. Induction time was measured when precipitation started, and the experiments were continued until equilibrium was reached. It was found that conductivity remained constant for more than 1800 minutes. The conductivity dropped from 17.35 mS/cm to 15.11 mS/cm, as shown in FIG. 5, when equilibrium was reached.

### Example 3

### Poly[sodium 5-(diallylcarboxymethylammonio)pentanoate]-alt-(sulfur dioxide)

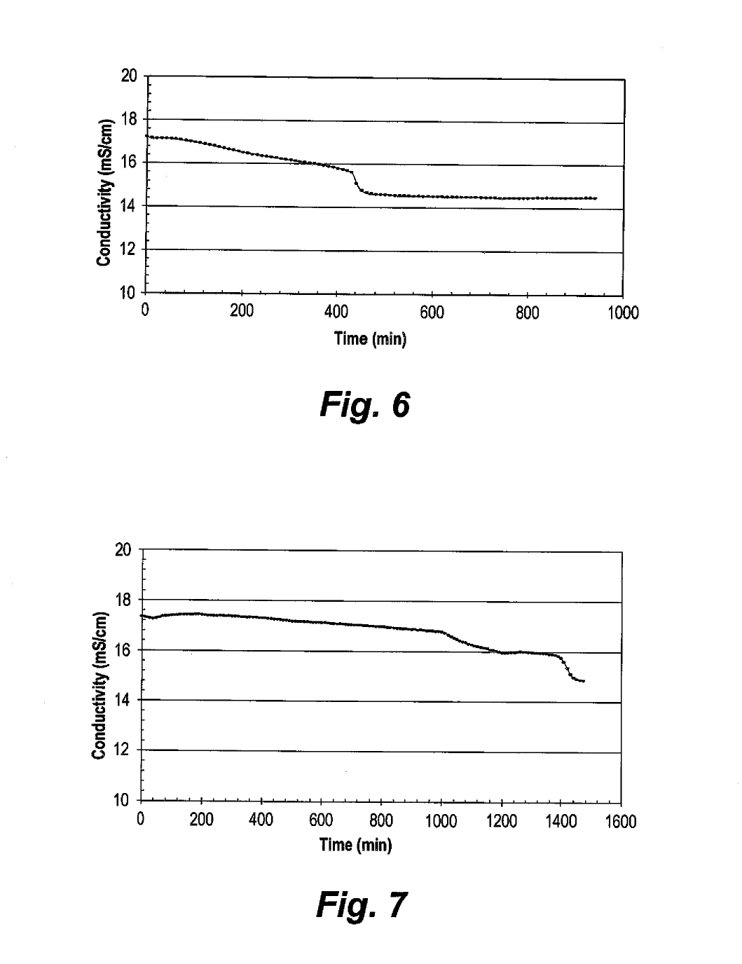

Next, about 60 ml of the 6 CB calcium chloride solution was taken in a two-neck round bottom flask and the antiscalant poly[sodium 5-(diallylcarboxymethylammonio)pentanoate]-alt-(sulfur dioxide), prepared as described in M. M. Ali, H. P. Perzanowski, and S. A. Ali, “Polymerization of functionalized diallyl quaternary salt to poly(ampholyte-electrolyte)”, Polymer, 41, 5591-5600 (2000), was added at a dose level of 10 ppm. The experiment to evaluate the additive poly[sodium 5-(diallylcarboxymethylammonio)pentanoate]-alt-(sulfur dioxide) was carried out as in the previous experiment for the first antiscalant composition. The induction time was found to be 90 minutes. Equilibrium concentration was reached after 470 minutes and the conductivity dropped from 17.16 mS/cm to 14.5 mS/cm. The precipitation behavior of 3 CB supersaturated solution with respect to CaSO₄ when poly[sodium 5-(diallylcarboxymethylammonio)pentanoate]-alt-(sulfur dioxide) was added is illustrated in FIG. 6.

### Example 4

### Poly[sodium 5-(diallylcarboxymethylammonio)pentanoate]

About 60 ml of the 6 CB calcium chloride solution was again taken in a two-neck round bottom flask and the third antiscalant poly[sodium 5-(diallylcarboxymethylammonio)pentanoate], prepared as described in M. M. Ali, H. P. Perzanowski, and S. A. Ali, “Polymerization of functionalized diallyl quaternary salt to poly(ampholyte-electrolyte)”, Polymer, 41, 5591-5600 (2000), was added at a dose level of 10 ppm. The experiment to evaluate the additive poly[sodium 5-(diallylcarboxymethylammonio)pentanoate] was carried out as in the previous two experimental evaluations. The induction time was found to be about 500 minutes. Equilibrium concentration was reached after 1400 minutes and the conductivity dropped from 17.30 mS/cm to 14.97 mS/cm. The precipitation behavior of 3 CB supersaturated solution with respect to CaSO₄ when poly[sodium 5-(diallylcarboxymethylammonio)pentanoate] was added is illustrated in FIG. 7.

The antiscalant poly[disodium 3-(diallylamino)propanephosphonate]-alt-(sulfur dioxide) composition was found to be comparable to conventional antiscalants. As a final control experiment, a conventional antiscalant was studied, and the conventional antiscalant, under similar experimental conditions, was found to produce an induction time of 1,880 minutes. The conductivity was measured at equilibrium. The conductivity dropped from 17.48 mS/cm to 14.92 mS/cm.

It is to be understood that the present invention is not limited to the embodiments described above, but encompasses any and all embodiments within the scope of the following claims.

We claim:

1. A calcium sulfate scale-inhibiting composition, comprising poly[disodium 3-(diallylamino)propanephosphonate]-alt-(sulfur dioxide).

2. A method of inhibiting calcium sulfate scale formation in desalination plant feed brine, comprising the step of mixing poly[disodium 3-(diallylamino)propanephosphonate]-alt-(sulfur dioxide) at a concentration between 1 ppm and 50 ppm into desalination plant feed brine.

3. The method of inhibiting calcium sulfate scale formation in desalination plant feed water as recited in claim 2, wherein the poly[disodium 3-(diallylamino)propanephosphonate]-alt-(sulfur dioxide) is mixed into the desalination plant feed brine at a concentration of approximately 10 ppm.

4. A method of inhibiting calcium sulfate scale formation in desalination plant feed brine, comprising the step of mixing a polyelectrolyte antiscalant composition at a concentration between 1 ppm and 50 ppm into desalination plant feed brine.

5. The method of inhibiting calcium sulfate scale formation in desalination plant feed brine as recited in claim 4, wherein the polyelectrolyte antiscalant composition comprises poly[disodium 3-(diallylamino)propanephosphonate]-alt-(sulfur dioxide).

6. The method of inhibiting calcium sulfate scale formation in desalination plant feed brine according to claim 5, wherein said step of mixing comprises mixing poly[disodium 3-(diallylamino)propanephosphonate]-alt-(sulfur dioxide) into the desalination feed brine to a concentration of about 10 ppm of the feed brine.

7. The method of inhibiting calcium sulfate scale formation in desalination plant feed brine as recited in claim 4, wherein the polyelectrolyte antiscalant composition comprises poly[sodium 5-(diallylcarboxymethylammonio)pentanoate]-alt-(sulfur dioxide).

8. The method of inhibiting calcium sulfate scale formation in desalination plant feed brine according to claim 7, wherein said step of mixing comprises mixing poly[sodium 5-(diallylcarboxymethylammonio)pentanoate]-alt-(sulfur dioxide) into the desalination feed brine to a concentration of about 10 ppm of the feed brine.

9. The method of inhibiting calcium sulfate scale formation in desalination plant feed brine as recited in claim 4, wherein the polyelectrolyte antiscalant composition comprises poly[sodium 5-(diallylcarboxymethylammonio)pentanoate].

10. The method of inhibiting calcium sulfate scale formation in desalination plant feed brine according to claim 9, wherein said step of mixing comprises mixing poly[sodium 5-(diallylcarboxymethylammonio)pentanoate] into the desalination feed brine to a concentration of about 10 ppm of the feed brine.
